(19) United States
(12) Patent Application Publication
(10) Pub. No.: US 2025/0109246 A1
(43) Pub. Date: Apr. 3, 2025

(54) NOVEL NONIONIC SURFACTANTS AND PROCESSES TO MAKE THEM

(71) Applicant: Dow Global Technologies LLC, Midland, MI (US)

(72) Inventors: Yusen Qiao, Lake Jackson, TX (US); Nima Nikbin, Lake Jackson, TX (US); Wanglin Yu, Pearland, TX (US)

(21) Appl. No.: 18/718,858

(22) PCT Filed: Dec. 15, 2022
(86) PCT No.: PCT/US2022/052917

§ 371 Date: Jun. 12, 2024

Related U.S. Application Data
(60) Provisional application No. 63/290,379, filed on Dec. 16, 2021.

(51) Int. Cl. C08G 64/18; C08G 64/32; C08G 64/34; C08G 65/26

(52) U.S. Cl. CPC C08G 64/183; C08G 64/323; C08G 64/34; C08G 65/2609; C08G 65/2663; C08G 2230/00; C08G 2650/22; C08G 2650/36; C08G 2650/38; C08G 2650/58

(57) ABSTRACT

In nonionic surfactants that contain blocks of hydrophobic poly(alkylene oxide) polymer linked to blocks of hydrophilic poly(alkylene oxide) polymer, the biodegradability of the polymer is improved if the hydrophobic blocks are polymerized in the presence of carbon dioxide to add poly (alkylene carbonate) units into the hydrophobic block, in which the alkylene carbonate units make up from 1 to 40 weight percent of the hydrophobic polymer blocks. The resulting nonionic surfactants can have similar surfactant performance but improved biodegradability, as compared to related surfactants without alkylene carbonate units.

### TECHNICAL FIELD

This application relates to the field of nonionic surfactants.

### BACKGROUND

Ethoxylated fatty alcohols are well known and commercially available for use as nonionic surfactants. The ethoxylated fatty alcohols and acids contain a hydrophilic polymer or oligomer having repeating ethylene ether units bonded to a hydrophobic aliphatic moiety which is the remnant of the fatty alcohol or acid. Examples include lauryl alcohol ethoxylate, stearyl alcohol ethoxylate and behenyl alcohol ethoxylate. They can be made by polymerizing ethylene oxide to form a hydrophilic polymer in the presence of the hydrophobic fatty alcohol, which provides a site to initiate polymerization and is bonded at the end of the polymer. See, for example, US Publication 2010/0317824 A1.

Many variations are known. In some nonionic surfactants the hydrophobic segment is extended by first polymerizing blocks of hydrophobic polymer before polymerizing blocks of hydrophilic polymer. For example, U.S. Pat. No. 9,874,079 B2 describes nonionic surfactants made by first polymerizing propylene oxide and/or butylene oxide and then second polymerizing ethylene oxide.

In some nonionic surfactants, the hydrophobic polymer blocks contain alkylene carbonate units, which can be made by copolymerizing alkylene oxide with carbon dioxide. Examples and processes to make them are described in U.S. Pat. Nos. 4,488,982; and 9,676,905 B2. For example, U.S. Pat. No. 8,580,911 B2 describes a surfactant having hydrophobic polymer blocks that contain alkylene carbonate units, a linking moiety and hydrophilic polymer blocks which may contain alkylene ether units. U.S. Pat. No. 4,866,143 describes a nonionic surfactant that contains (a) hydrophilic segments selected from polyoxyalkylene polyether, a saccharide, a saccharide polyoxyalkylenate, a polycarbonate having a carbon dioxide content of from about 1 to 15 molar percent and mixtures thereof and (b) hydrophobic segments comprising alkylene and alkylene carbonate units arranged in alternating or random order to form a polymer having a total carbon dioxide content of from about 25 to 50 molar percent and a total molecular weight of from about 300 to 10,000.

Certain double metal cyanide catalysts are useful to polymerize alkylene oxides alone or in the presence of carbon dioxide, using an acid or alcohol starter. See, for example, U.S. Pat. Nos. 6,429,342 B1 and 9,676,905 B2.

It is desirable to explore different variations of nonionic surfactants that have useful properties.

### SUMMARY

One aspect of the present invention is a nonionic surfactant comprising:
a) hydrophobic polymer blocks that contain on average from 60 to 99 weight percent alkylene ether repeating units and from 1 to 40 weight percent alkylene carbonate repeating units, based on the combined weight of alkylene ether repeating units and alkylene carbonate repeating units; and
b) hydrophilic polymer blocks that contain alkylene ether repeating units.
   For clarity, in this document the term “polymer” includes blocks that have only a few repeating units or only two repeating units, so the term “polymer” may read on blocks that in other publications might be called “dimers” or “oligomers.” Likewise, the term “polymerization” also covers reactions that other publications may call “dimerization” or “oligomerization.”

A second aspect of the present invention is a process to make a nonionic surfactant comprising the steps of:
a) A first polymerization step in which a first alkylene oxide component is polymerized in the presence of carbon dioxide, an alcohol or organic acid and a catalyst under conditions such that hydrophobic polymer blocks are formed that contain on average from 60 to 99 weight percent alkylene ether repeating units and from 1 to 40 weight percent alkylene carbonate repeating units, based on the combined weight of alkylene ether repeating units and alkylene carbonate repeating units; and
b) A second polymerization step in which a second alkylene oxide component is polymerized in the presence of hydrophobic polymer blocks from step (a) and a catalyst, under conditions such that hydrophilic polymer blocks that contain alkylene ether repeating units are formed attached to the hydrophobic blocks.

In certain embodiments, the presence of alkylene carbonate units in the hydrophobic polymer blocks may give nonionic surfactants of the present invention enhanced biodegradability or may give the hydrophobic polymer blocks enhanced hydrophobicity. In addition, the use of carbon dioxide to make the polyether polycarbonate blocks enables the use of carbon dioxide in a way that will prevent or delay its release into the atmosphere.

### DETAILED DESCRIPTION

Surfactants of the present invention are made in two steps. In the first step, hydrophobic polymer blocks are made by polymerizing a first alkylene oxide component and carbon dioxide in the presence of a catalyst and an organic acid or alcohol, which serves as an initiation site for polymerization; the organic acid or alcohol is called a “starter compound” in some references. In the second step, hydrophilic polymer blocks are attached to the hydrophobic blocks by polymerizing a second alkylene oxide component in the presence of a catalyst and the hydrophobic polymer blocks from the first step polymerization.

### First Polymerization Step

The first polymerization step takes place in the presence of an alcohol or organic acid, which is called a starter compound. In some embodiments, the starter compound is an alcohol, and in some embodiments, it is a carboxylic acid. In some embodiments, the starter compound is aliphatic. An aliphatic starter compound may be saturated or monounsaturated or polyunsaturated; in some embodiments it is saturated. In some embodiments the starter compound contains one or more alkyl branches, such as methyl or ethyl branches. In some embodiments the starter compound contains on average at least 1 or at least 2 or at least 3 or at least 4 or at least 6 carbon atoms per molecule. In some embodiments the starter compound contains on average at most 30 carbon atoms or at most 26 carbon atoms or at most 24 carbon atoms or at most 20 carbon atoms per molecule. In some embodiments, the starter is hydrophobic. Examples of starter compounds include methanol, ethanol, butanol, hexanol, octanol, nonanol, decanol, undecanol, dodecanol, tridecanol, tetradecanol, pentadecanol, hexadecanol, heptadecanol, octadecanol, nonadecanol, eicosanol, 2-ethylhexanol, 2-propylheptanol, 2-butyloctanol, and a mixture of any above alcohols. Other examples of the starter compound include C8-10, C12-14, C10-14, C10-16, C12-16, and C16-18 fatty alcohols derived from plant oils, oxo alcohols under the trade name of NEODOL from Shell Chemicals, alcohol products under the trade names of Alfol, Safol, Marlipal, Isochem, Lial, Alchem, and Isofol from Sasol, and Exxal alcohols from ExxonMobil.

Examples of starter compounds meet Formula 1:

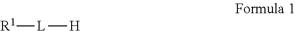

Wherein R¹ is an organic moiety and L is either —O— or —CO₂—. Embodiments of R¹ may reflect the number of carbon atoms, saturation or unsaturation and branching described above.

The starter compound is contacted with a first alkylene oxide component, carbon dioxide and a catalyst under conditions such that the first alkylene oxide component and the carbon dioxide polymerize to form hydrophobic polymer blocks that contain both (a) alkyl ether units from ring opening of first alkylene oxide component and (b) alkyl carbonate units from reaction of the first alkylene oxide component with the carbon dioxide. Examples of the two reactions are shown in

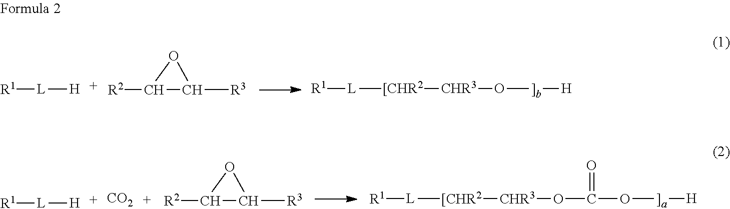

Formula 2 (1) and (2)
wherein R¹ and L have the description previously given, each R² and R³ is independently hydrogen or an alkyl group, b is a number of alkylene ether units and a is a number of alkylene carbonate units. For clarity, both reactions (1) and (2) may happen simultaneously to make a copolymer that contains both alkylene ether units and alkylene carbonate units, and the relative rates of each reaction (and the relative proportions of alkylene ether units and alkylene carbonate units) can vary depending on the catalyst that is selected and the conditions of the reaction.

The first alkylene oxide component, which is used to make hydrophobic polymer blocks in the first polymerization step, may comprise a single alkylene oxide or a mixture of multiple alkylene oxides. Alkylene oxide molecules in the first alkylene oxide component predominantly contain at least 3 carbon atoms. Some embodiments of the first alkylene oxide component comprises on average at least 3 carbon atoms per molecule or at least 3.25 or at least 3.5 carbon atoms per molecule. Some embodiments of the first alkylene oxide component comprises on average at most 6 or at most 5 or at most 4 carbon atoms per molecule. Common examples of the first alkylene oxide component include propylene oxide and butylene oxide and mixtures of propylene oxide and butylene oxide.

The first alkylene oxide component may contain small quantities of ethylene oxide, if the quantity of ethylene oxide is small enough that the resulting polymer blocks remain hydrophobic. In many embodiments, the quantity of ethylene oxide in the first alkylene oxide component is less than 20 mole percent or less than 10 mole percent or less than 5 mole percent or less than 3 mole percent, based on the total quantity of alkylene oxide. In some embodiments, the first alkylene oxide component contains essentially no (0 mole percent) ethylene oxide.

The first alkylene oxide component can meet Formula 3:

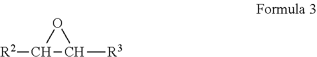

Wherein each R² and R³ is independently hydrogen or an alkyl group. Exemplary embodiments of R² and R³ meet the description of first alkylene oxide component previously given. In some embodiments, R² and R³ together contain on average at least 1 carbon or at least 1.5 carbon atoms or at least 2 carbon atoms. In some embodiments, R² and R³ together contain on average at most 6 carbon atoms or at most 5 carbon atoms or at most 4 carbon atom atoms or at most 3 carbon atoms or at most 2 carbon atom atoms.

The first polymerization also takes place in the presence of carbon dioxide. The amount of carbon dioxide depends on the catalyst and reaction conditions used, which govern the effectiveness with which carbon dioxide is incorporated into the hydrophobic polymer blocks. In some embodiments the reaction conditions are selected such that the average uptake of carbon dioxide into the hydrophobic polymer blocks is at least 5 weight percent or at least 10 weight percent or at least 12 weight percent or at least 15 weight percent. In some embodiments the reaction conditions are selected such that the average uptake of carbon dioxide into the hydrophobic polymer blocks is no more than 20 weight percent or no more than 18 weight percent or no more than 15 weight percent.

For catalysts and reaction conditions that preferentially catalyze formation of alkyl carbonate units, the weight ratio of carbon dioxide to first alkylene oxide component may optionally be at least 5 percent or at least 10 percent or at least 12 percent or at least 15 percent; it may optionally be at most 20 percent or at most 18 percent or at most 15 percent. For catalysts and reaction conditions that catalyze formation of substantial alkylene ether units, exemplary weight ratios of carbon dioxide to first alkylene oxide component may be higher.

The first polymerization step takes place in the presence of a catalyst. In cationic polymerization of alkylene oxides, examples of suitable catalysts include protic acids (HClO4, HCl), Lewis acids (SnCl4, BF3, etc.), organometallic compounds, or more complex reagents. In anionic polymerization of alkylene oxides, examples of suitable catalysts include bases, such as alkoxides, hydroxides, carbonates or other compounds of alkali or alkaline earth metals.

Some catalysts are known to preferentially catalyze the formation of alkylene carbonate or alkylene ether units or to catalyze both reactions. For example, U.S. Pat. No. 8,247,520 B2 describes metal complex catalysts that catalyze formation of alkylene carbonate units almost exclusively with almost no alkylene ether unit formation. See also Coates, G. et al. “Cobalt-Based Complexes for the Copolymerization of Propylene Oxide and CO2: Active and Selective Catalysts for Polycarbonate Synthesis” Angew. Chem. Int. Ed. 2003, 42, 5484-5487. On the other hand, PCT Publication WO 2018/089566 describes double metal cyanide catalysts that catalyst both alkylene carbonate and alkylene ether formation; reaction conditions determine which reaction predominates.

In some embodiments of the present invention, the catalyst contains a double metal cyanide (“DMC”) catalyst. Double metal cyanide catalysts and their production are discussed in patents such as U.S. Pat. Nos. 6,291,388 B1; 6,355,845 B1; 6,429,342 B1; 6,642,423 B1; 9,040,657 B1 and PCT Publications WO 01/90217 A1 and WO 2018/089566 A1. Exemplary DMC catalysts can be represented by the Formula 4:

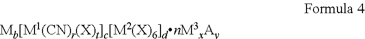

wherein M and M³ are each metals; M¹ is a transition metal different from M, each X represents a group other than cyanide that coordinates with the M¹ ion; M² is a transition metal; A represents an anion; b, c and d are numbers that reflect an electrostatically neutral complex; r is from 4 to 6; t is from 0 to 2; x and y are integers that balance the charges in the metal salt M³ₓA_{y}, and n is zero or a positive integer. The foregoing formula does not reflect the presence of neutral complexing agents such as t-butanol which are often present in the DMC catalyst complex. In exemplary embodiments, r is 4 or 6, t is 0. In some instances, r+t will equal six.

For example, M and M³ may each be a metal ion independently selected from the group of Zn²⁺, Fe²⁺, Co²⁺, Ni²⁺, Mo⁴⁺, Mo⁶⁺, Al³⁺, V⁴⁺, V⁵⁺, Sr²⁺, W⁴⁺, W⁶⁺, Mn²⁺, Sn²⁺, Sn⁴⁺, Pb²⁺, Cu²⁺, La³⁺ and Cr³⁺. M¹ and M² may each be selected from the group of Fe³⁺, Fe²⁺, Co²⁺, Co³⁺, (V³⁺, Cr³⁺, Mn²⁺, Mn³⁺, Ir³⁺, Ni²⁺, R³⁺, Ru²⁺, Y⁴⁺, V⁵⁺, Pd²⁺ and Pt²⁺. Among the foregoing, those in the plus-three oxidation state may be used as the M¹ and M² metal (e.g., Co³⁺ and Fe³⁺). Suitable anions A include, but are not limited, to halides such as chloride, bromide and iodide, nitrate, sulfate, carbonate, cyanide, oxalate, thiocyanate, isocyanate, perchlorate, isothiocyanate, an alkanesulfonate such as methanesulfonate, an arylenesulfonate such as p-toluenesulfonate, trifluoromethanesulfonate (triflate) and a C₁₋₄ carboxylate.

An exemplary type of DMC catalyst is a zinc hexacyanocobaltate complexed with t-butanol. An exemplary double metal cyanide catalyst is commercially available as Arcol Catalyst 3 from Covestro.

In some embodiments, a DMC catalyst is used together with a catalyst promoter that does not contain halide anions or cyanide, as described in PCT Publication WO 2018/089566A1. For example, the catalyst promoter may comprise magnesium, a Group 3-Group 15 metal, or a lanthanide series metal bonded to at least one alkoxide, aryloxy, carboxylate, acyl, pyrophosphate, phosphate, thiophosphate, dithiophosphate, phosphate ester, thiophosphate ester, amide, siloxide, hydride, carbamate or hydrocarbon anion, wherein the magnesium, Group 3-Group 15 metal, or lanthanide series metal compound is devoid of halide anions and cyanide. In some exemplary embodiments, the metal in the promoter is magnesium. Exemplary promoters are discussed in U.S. Pat. No. 9,040,657 (col. 9-12).

Polymerization of alkylene oxide with DMC catalyst may require activation of the catalyst. During activation, the DMC catalyst is believed to become converted in situ from an inactive form into a highly active form that rapidly polymerizes the alkylene oxide if it remains active. Activation may be carried out by heating the catalyst, optionally in the presence of the starter compound, the alkylene oxide(s) and/or the carbon dioxide. The catalyst activation period is typically an indeterminate period of time following the first introduction of alkylene oxide (such as propylene oxide) to the reactor. It is common to introduce a small amount of alkylene oxide and starter compound at the start of the polymerization process and then wait unit the catalyst has become activated (as indicated, e.g., by a drop in reactor pressure due to the consumption of the initial alkylene oxide charge) before continuing with the alkylene oxide feed.

The catalyst may be activated during a preliminary stage before full polymerization begins (such as in a semibatch process), or the catalyst may be activated in the polymerization reactor during the polymerization stage (such as in a continuous process). Catalyst activation in a preliminary stage may be performed optionally with or without the presence of carbon dioxide in the reactor. In continuous operations, the catalyst activation may occur simultaneously with polymerization, as new unactivated catalyst, alkylene oxide, carbon dioxide, and a starter are introduced continuously into the reactor.

In a process that includes preliminary activation, the catalyst activation may occur at an activation temperature and at least a portion of the polymerization stage may be performed at a polymerization temperature that is different from the activation temperature. The activation temperature may be higher or lower than the polymerization temperature; in some embodiments the activation temperature is higher than the polymerization temperature. In some embodiments, the activation temperature may be equal to or greater than 50° C., than 120° C., and/or than 150° C. In some embodiments, the polymerization temperature may be equal to or greater than 50° C. In some embodiments, the activation temperature and/or the polymerization temperature may be independently less than 165° C. For example, the polymerization temperature may be within the range from 50° C. to 165° C. (e.g., from 65° C. to 155° C., from 80° C. to 150° C., and/or from 90° C. to 140° C.). In some embodiments, the difference between the activation temperature and the polymerization temperature may be at least 10° C., at least 20° C., at least 30° C., at least 40° C., and/or at least 50° C. Optionally, the activation temperature and the polymerization temperature may be the same temperature.

In some embodiments, the reaction conditions may be selected to provide hydrophobic polymer blocks that have a weight average molecular weight of at least 114 or at least 171 or at least 228. In some embodiments, the reaction conditions may be selected to provide hydrophobic polymer blocks that have a weight average molecular weight of at most 2000 or at most 1500 or at most 750. In some embodiments, the reaction conditions are selected such that the degree of polymerization of the hydrophobic polymer blocks averages at least 2 or at least 3 or at least 4. In some embodiments, the reaction conditions are selected such that the degree of polymerization of the hydrophobic polymer blocks averages at most 35 or at most 25 or at most 13.

The first polymerization step may be a single polymerization, resulting in hydrophobic polymer blocks in which the alkylene carbonate units and alkylene ether units are distributed randomly throughout the polymer. Alternately, the first polymerization step may be carried out in two or more stages with different monomer mixtures, so that the resulting hydrophobic polymer blocks contain segments with higher and lower concentrations of alkylene carbonate units. For example, the first polymerization step may begin with just the first alkylene oxide component so that the repeating units nearest to the starter compound comprise predominantly alkylene ether repeating units, and then carbon dioxide may be introduced into the polymerization later, so that the poly(alkylene ether) segments are capped with segments containing poly(alkylene carbonate) units.

The first polymerization step produces hydrophobic polymer blocks, which are further described below. The hydrophobic polymer blocks may be recovered before the second polymerization step, or the second polymerization step polymerization can be initiated in-situ by adjusting the alkylene oxide monomers and carbon dioxide content in the reactor.

### Hydrophobic Polymer Blocks

The hydrophobic polymer blocks produced in the first polymerization step have a structure that would be expected from the raw materials. They contain repeating alkylene ether and alkylene carbonate units. In many embodiments, the hydrophobic polymer blocks further comprise an organic moiety bonded to one repeating unit by an ether (—O—) or ester (—CO₂—) linkage. The organic moiety is a residue of the starter compound, and in many embodiments, it caps one end of the hydrophobic polymer blocks.

Examples of weight average molecular weight and degree of polymerization for the hydrophobic polymer blocks are described previously. Alkylene groups in the hydrophobic polymer blocks correspond with alkylene groups in the first alkylene oxide component as described above.

Alkylene carbonate repeating units make up on average from 1 to 40 weight percent of the hydrophobic polymer blocks, based on the combined weight of the alkylene carbonate units and the alkylene ether units (which excludes the remnant of the starter compound). In some embodiments, alkylene carbonate units make up on average at least 2 weight percent or at least 5 weight percent or at least 8 weight percent or at least 10 weight percent of the hydrophobic polymer blocks, based on the combined weight of the alkylene carbonate units and the alkylene ether units. In some embodiments, alkylene carbonate units make up on average at most 35 weight percent or at most 30 weight percent or at most 25 weight percent of the hydrophobic polymer blocks, based on the combined weight of the alkylene carbonate units and the alkylene ether units.

Alkylene ether repeating units make up on average from 60 to 99 weight percent of the hydrophobic polymer blocks, based on the combined weight of the alkylene carbonate units and the alkylene ether units (which excludes the remnant of the starter compound). In some embodiments, alkylene ether units make up on average at most 98 weight percent or at most 95 weight percent or at most 92 weight percent or at most 90 weight percent of the hydrophobic polymer blocks, based on the combined weight of the alkylene carbonate units and the alkylene ether units. In some embodiments, alkylene ether units make up on average at least 65 weight percent or at least 70 weight percent or at least 75 weight percent of the hydrophobic polymer blocks, based on the combined weight of the alkylene carbonate units and the alkylene ether units.

In some embodiments, the average molar ratio of alkylene ether units to alkylene carbonate units is at least 3:1 or at least 4:1 or at least 5:1 in the hydrophobic polymer blocks. In some embodiments, the average molar ratio of alkylene ether units to alkylene carbonate units is at most 20:1 or at most 15:1 or at most 10:1 in the hydrophobic polymer blocks. In some embodiments, at least 20 mole percent of the hydrophobic polymer blocks contain at least one alkylene carbonate unit or at least 30 mole percent or at least 40 mole percent or at least 50 mole percent or at least 60 mole percent or at least 70 mole percent. In some embodiments, up to 100 mole percent of the hydrophobic polymer blocks contain at least one alkylene carbonate unit.

In some embodiments, the hydrophobic polymer blocks have the structure in Formula 5:

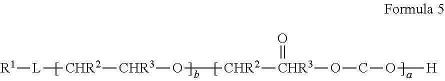

Wherein:
   R¹, R², R³ and L each have the meaning and embodiments previously defined. For example, R¹ may be an aliphatic moiety containing from 1 to 30 carbon atoms. For example, R² and R³ may each independently be hydrogen or an alkyl moiety which contain on average for each repeating unit from 1 to 6 carbon atoms.
   b is a number of alkylene ether repeating units and a is a number of alkylene carbonate repeating units, selected such alkylene carbonate repeating units make up on average from 1 to 40 weight percent of the hydrophobic polymer blocks and alkylene ether repeating units make up on average from 60 to 99 weight percent of the hydrophobic polymer blocks, based on the combined weight of the alkylene carbonate units and the alkylene ether units. Examples of a and b correspond to the exemplary degree of polymerization and ratios of repeating units described previously.
   Both the alkylene ether repeating units and the alkylene carbonate repeating units may be distributed throughout the hydrophobic polymer block, and the first unit attached to L may be either an alkylene ether unit or an alkylene carbonate unit.

### Second Polymerization Step

In the second polymerization step, the hydrophobic polymer blocks are contacted with a second alkylene oxide component in the presence of a catalyst under conditions suitable to form hydrophilic polymer blocks bonded to the hydrophobic polymer blocks.

The second alkylene oxide component comprises ethylene oxide. The second alkylene oxide component may further comprise other alkylene oxide comonomers if the portion of ethylene oxide is high enough so that the resulting polymer blocks are hydrophilic. Some embodiments of other alkylene oxide comonomers comprise at most 8 carbon atoms per molecule or at most 6 carbon atoms per molecule. Some embodiments of other alkylene oxide comonomers comprise at least 3 carbon atoms. Common examples of the other alkylene oxide comonomers include propylene oxide and butylene oxide. In many embodiments, the quantity of other alkylene oxide comonomers is no more than 50 mole percent or no more than 30 mole percent or no more than 20 mole percent or no more than 10 mole percent, based on the total quantity of alkylene oxide. The quantity of other alkylene oxide comonomers may be 0 mole percent or higher. Correspondingly, in many embodiments the second alkylene oxide component contains at least 50 mole percent or at least 70 mole percent or at least 80 mole percent or at least 90 mole percent ethylene oxide, up to 100 mole percent ethylene oxide. The second alkylene oxide component contains on average at least 2 carbon atoms per molecule. In some embodiments, the second alkylene oxide component contains on average at most 2.7 carbon atoms per molecule or at most 2.5 carbon atoms per molecule or at most 2.3 carbon atoms per molecule.

Exemplary second alkylene oxide components can meet Formula 6:

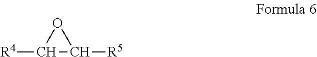

Wherein each R⁴ and R⁵ is independently hydrogen or an alkyl group selected such that the resulting polymer is hydrophilic. In some embodiments, R⁴ and R⁵ together contain on average at least 0 carbon atoms. In some embodiments, R⁴ and R⁵ together contain on average at most 1 carbon or at most 0.5 carbon atoms or at most 0.25 carbon atoms or at most 0.15 carbon atoms or at most 0.1 carbon atoms.

The second polymerization step takes place in the presence of a catalyst. The catalyst has the same description and exemplary embodiments as the catalyst used in the first polymerization step. It may be the same as the catalyst used in the first polymerization step, or it may be different. In some embodiments, at least part of the catalyst used in the second polymerization step is residual catalyst that is contained in the hydrophobic polymer blocks from the first polymerization step.

In cationic polymerization of alkylene oxides, examples of suitable catalysts include protic acids (HClO₄, HCl), Lewis acids (SnCl₄, BF₃, etc.), organometallic compounds, or more complex reagents. In anionic polymerization of alkylene oxides, examples of suitable catalysts include bases, such as alkoxides, hydroxides, carbonates or other compounds of alkali or alkaline earth metals. In some embodiments of the present invention, the catalyst used in the second polymerization step contains a double metal cyanide catalyst (“DMC catalyst”) as previously described. In some embodiments, the DMC catalyst is used with a promoter as previously described.

Polymerization conditions in the second polymerization step have the same limits and exemplary embodiments as the first polymerization step and are selected such that the second polymerization produces hydrophilic polymer blocks attached to the hydrophobic polymer blocks.

In the second polymerization step, the weight ratio of second alkylene oxide component to hydrophobic polymer blocks (including weight of the starter) is selected so that the product of the second polymerization step is surface active. In some embodiments, the weight ratio of second alkylene oxide component to hydrophobic polymer blocks in the second polymerization is at least 0.3 or at least 0.4 or at least 0.5. In some embodiments, the weight ratio of second alkylene oxide component to hydrophobic polymer blocks in the second polymerization is at most 6 or at most 9 or at most 11.

In some embodiments, the resulting hydrophilic polymer blocks have a weight average molecular weight of at least 100 or at least 150 or at least 200. In some embodiments, the resulting hydrophilic polymer blocks have a weight average molecular weight of at most 3000 or at most 2000 or at most 1500. In some embodiments, the resulting hydrophilic polymer blocks have a degree of polymerization of at least 3 or at least 4 or at least 5. In some embodiments, the resulting hydrophilic polymer blocks have a degree of polymerization of at most 70 or at most 40 or at most 35.

The second polymerization step may include polymerization of minor amounts of carbon dioxide, so that alkylene carbonate units are formed, if the quantity of alkylene carbonate units is low enough that the polymer blocks remain hydrophilic. For example, U.S. Pat. No. 4,866,143 describes a nonionic surfactant that contains hydrophilic polymer blocks which contain alkylene ether and alkylene carbonate units having a residual carbon dioxide content of from about 1 to 15 molar percent. In some embodiments, the incorporation of carbon dioxide in the second polymerization step is no more than 10 mole percent, or no more than 5 mole percent or no more than 3 mole percent. In some embodiments, essentially no (0 mole percent) carbon dioxide is incorporated into the hydrophilic polymer blocks during the second polymerization step.

The product of the second polymerization step is a nonionic surfactant. The surfactant may be recovered as neat product. Optionally, water or an organic solvent, such as ethanol or isopropanol, may be added to reduce viscosity.

Residual alkylene oxide can be removed from the surfactant product by known means such as nitrogen sparging or flushing or applying a vacuum at ambient or elevated temperature.

Depending on the catalyst used and the requirements for the surfactant, residual catalyst can be removed by known means, such as filtration or ion exchange, or residual catalyst may be neutralized, such as neutralizing basic catalysts with acid such as acetic acid, propionic acid or phosphoric acid. Known methods for removing DMC catalyst frequently involve precipitating the catalyst or adsorbing onto a granular adsorbent and then filtering the precipitate or adsorbent. Exemplary methods and sources that describe them are described in US Patent Publication 2019/0119444 A1. Other methods may also be effective.

### Surfactant

The product of the second polymerization is a nonionic surfactant. The nonionic surfactant contains blocks of hydrophobic polymer that contain both alkyl ether repeating units and alkyl carbonate repeating units. The nonionic surfactant further contains blocks of hydrophilic polymer that contain alkyl ether repeating units.

In many embodiments, the hydrophobic polymer blocks further comprise an organic moiety (R¹) bonded to one repeating unit by an ether or ester linkage (L=—O— or —CO₂—). The organic moiety is a remnant of the starter compound from the first polymerization step. In some embodiments, it is aliphatic or alkyl. In some embodiments the organic moiety contains on average at least 1 or 2 or 3 or 4 carbon atoms or 6 carbon atoms. In some embodiments the organic moiety contains on average at most 30 carbon atoms or at most 26 carbon atoms or at most 24 carbon atoms or at most 20 carbon atoms. In many embodiments, the organic moiety caps one end of the hydrophobic polymer block, and the hydrophilic polymer blocks cap the opposite end of the hydrophobic polymer blocks.

The content and size of the hydrophobic polymer blocks is previously described.

The alkylene ether repeating units in the hydrophilic polymer blocks reflect the second alkylene oxide component used in the second polymerization step. In many embodiments, the alkyl group in the alkylene ether repeating groups of the hydrophilic polymer blocks is an ethylene group for at least 50 mole percent of the repeating units or at least 70 mole percent or at least 80 mole percent or at least 90 mole percent ethylene oxide, up to 100 mole percent of the repeating units in the hydrophilic blocks. Other repeating units reflect the description of comonomers in the second polymerization step. In some embodiments, the alkyl group in the other repeating units contains no more than 6 carbon atoms or no more than 4 carbon atoms or no more than 3 carbon atoms. In some embodiments, alkylene groups in the hydrophilic polymer blocks contain on average from 2 to 2.7 carbon atoms or from 2 to 2.5 carbon atoms or from 2 to 2.3 carbon atoms, per alkylene group.

The molecular weight and degree of polymerization of the hydrophilic polymer blocks is previously described. In some embodiments, the surfactant contains on average at least 20 weight percent hydrophilic polymer blocks or at least 30 weight percent or at least 40 weight percent. In some embodiments, the surfactant contains on average at most 90 weight percent hydrophilic polymer blocks or at most 80 weight percent or at most 70 weight percent. In some embodiments, the hydrophobic polymer blocks in the surfactant (including remnant of the starter compound) make up on average at least 10 weight percent of the surfactant or at least 20 weight percent or at least 30 weight percent. In some embodiments, the hydrophobic polymer blocks in the surfactant (including remnant of the starter compound) make up on average at most 80 weight percent of the surfactant or at most 70 weight percent or at most 60 weight percent.

Examples of the nonionic surfactant can meet Formula 7 below:

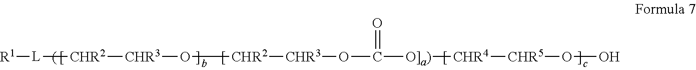

Wherein:
   R¹ is the organic moiety previously described.
   L is an ether linking group (—O—) or an ester linking group (—CO₂—).
   Each R² and R³ is independently hydrogen or an alkyl moiety as previously described in describing the first alkylene oxide component.
   Each R⁴ and R⁵ is independently hydrogen or an alkyl moiety as previously described in describing the second alkylene oxide component.
   The repeating units between the parentheses ( ) form the hydrophobic polymer block(s), and the repeating units outside the parentheses form the hydrophilic polymer block(s).
   b is a number of alkylene ether repeating units in the hydrophobic polymer block(s), a is a number of alkylene carbonate repeating units in the hydrophobic polymer block(s), and c is a number of alkylene ether repeating units in the hydrophilic polymer block(s), selected such that alkylene ether repeating units make up 60 to 99 weight percent of the hydrophobic polymer block and alkylene carbonate repeating units make up from 1 to 40 weight percent of the hydrophobic polymer block.
   The alkylene ether repeating units and the alkylene carbonate repeating units in the hydrophobic polymer block(s) may be randomly or alternately distributed or the hydrophobic polymer block(s) may have segments containing higher or lower concentrations of alkylene carbonate units, and the first unit attached to the linking group L may be an alkylene ether unit or an alkylene carbonate unit.

In Formula 7, R², R³, R⁴ and R⁵ have exemplary embodiments that were previously described. In some embodiments of Formula 6:
a is at least 0.5 or 0.7 or 1;
a is at most 18 or 13 or 7;
b is at least 2 or 3 or 4;
b is at most 35 or 25 or 13;
c is at least 3 or 4 or 5; and
c is at most 70 or 40 or 30.

In some embodiments, the surfactant has a critical micelle concentration (CMC) of at least 20 ppm or at least 50 ppm or at least 100 ppm, when measured as described in the Test Methods. In some embodiments, the surfactant has a critical micelle concentration (CMC) of at most 2000 ppm or at most 1500 ppm or at most 1000 ppm or at most 500 ppm, when measured as described in the Test Methods.

In some embodiments, an aqueous solution containing 0.1 weight percent of the surfactant has a surface tension of at most 40 dynes/cm or at most 35 dynes/cm or at most 32 dynes/cm, when measured as described in the Test Methods. There is no minimum desired surface tension, but in some embodiments, an aqueous solution containing 0.1 weight percent of the surfactant has a surface tension of at least 25 dyne/cm³ or at least 27 dyne/cm³, when measured as described in the Test Methods.

The inclusion of alkyl carbonate repeating units in the surfactant can increase the biodegradability of the surfactant. Biodegradability can be measured by D_{CO2}, as described in the Test Methods. In some embodiments, surfactants of the present invention have a percent biodegradability (D_{CO2}) of at least 60% after 28 days testing according to the Test Methods.

### Test Methods

Carbon 13 NMR: Samples are prepared as an approximately 50% solutions in Acetone-d6 with 0.025 M Cr(AcAc)₃ in 10 mm NMR tubes. The data is collected using a Bruker Avance III 400 MHz spectrometer equipped with a cryoprobe using 160 transient scans and a 6 second pulse repetition delay. The acquisition is carried out using a spectral width of 25000 Hz and a file size of 32K data points.

Surface Tension and Critical Micelle Concentration: Surface tension and critical micelle concentration (CMC) of the samples are obtained on a KRUSS Tensiometer K-100 using a Wilhelmy plate at 25° C. in water. Surface tension change with concentration is measured by incrementally adding a surfactant to deionized water, and CMC values are determined using KRUSS LabDesk Software for Force Tensiometer K100.

Draves Wetting: Draves Wetting time is tested following the procedures of ASTM D 2281-68 (Standard Test Method for Evaluation of Wetting Agents by the Skein Test). The tests are carried out at 0.1 weight percent concentration of surfactant and at room temperature.

Biodegradability: Biodegradability is measured using OECD Guideline No. 301B: CO₂ Evolution Test. Activated sludge inoculum is collected from two public waste treatment facilities and is suspended in a defined mineral medium at a concentration of 29.9-30.0 mg/L (dry solids). Each surfactant is coated onto silica gel powder, which is dispersed into duplicate test bottles containing inoculated mineral medium (two for each sludge mixture) at a concentration of 12-24 mg/L, which was equivalent to 30-52 mg/L theoretical carbon dioxide yield (ThCO₂). Reaction mixtures are incubated in the darkness at a constant temperature between 20 to 24° C., and maintained within ±1° C. Carbon dioxide production in the biodegradation reaction mixtures is continuously recorded at 6 hr intervals, using an automated respirometer system.

The measurement D_{CO2} (called % degradation in the OECD Guideline) is calculated by the formula:

D_{CO2}=([mg CO₂ produced]/[ThCO₂×mg Test Substance added])×100
wherein ThCO₂ is the quantity of carbon dioxide calculated to be produced from the known or measured carbon content of the test compound when fully mineralized; also expressed as mg carbon dioxide evolved per mg test compound as shown in Annex IV.2 of OECD Guideline 301.

### EXAMPLES

### Example 1: Synthesis of Hydrophobic Polymer Intermediates

Inventive Examples: The following ingredients are added into a 500 mL stainless steel reactor in quantities shown in Table 1: 2-ethyl-1-hexanol (as the starter material), Arcol 3 DMC (Double Metal Cyanide) catalyst, and aluminum tri-sec-butoxide (as the catalyst promoter). The reactor is closed and placed under nitrogen sparge overnight at room temperature to inert the atmosphere. The reactor is pressurized with 10 psig dry nitrogen, heated to 160° C., and held for 1 hr to allow the promoter to undergo thermolysis. The reactor is cooled to ambient temperature, the pressure is released and nitrogen sparge is continued.

The reactor is then heated to the reaction temperature shown in Table 1 over 1 hr with a continuous sparge and maintained at that temperature throughout the reaction. The nitrogen sparge is then turned off and the reactor is isolated. A 15 mL quantity of propylene oxide is fed to the reactor at a flow rate of <1.5 mL/min. The feed is stopped, and the pressure is allowed to decline to the initial pressure or until heat evolution has ceased. Then propylene oxide and carbon dioxide are fed to the reactor to obtain the quantities shown in Table 2. After the desired quantities of reagents are added, the propylene oxide feed and carbon dioxide feed are turned off and the reactor pressure is allowed to decline.

When the reactor pressure does not decline anymore, the reactor is slowly vented to the scrubber while carbon dioxide is sparged through the reactor body. Once the reactor atmosphere has reached ambient pressure, the sparge is allowed to continue for 30 mins after which the atmosphere is replaced with nitrogen and the reactor is allowed to cool to ambient temperature. As the reactor is cooling, the residual propylene oxide in the feed line is swept clear by flushing with nitrogen. When the reactor is at ambient temperature, the hydrophobic polymer intermediate product is collected. The hydrophobic polymer intermediate product contains residual DMC Catalyst and promoter.

TABLE 1

| Sample ID | Int 1 | Int 2 | Int 3 |
|---|---|---|---|
| Reaction Conditions | | | |
| Catalyst concentration by weight per | 200 | 100 | 150 |
| hydrophobic polymer blocks (ppm) | | | |
| Promoter:DMC ratio: Al:Zn (mol) | 6:1 | 6:1 | 6:1 |
| Temperature [C.] | 80 | 100 | 100 |
| N2 purge temperature [C.] | 130 | Ambient | Ambient |
| N2 flow rate [SCFH] | 3 | 0.5 | 0.5 |
| N2 purge time [h] | 1 | Overnight | Overnight |
| Quantities Fed to Reactor | | | |
| 2-ethylhexanol (g) | 87.7 | 87.7 | 77.4 |
| Propylene Oxide (g) | * | 281.1 | 168.0 |
| Carbon Dioxide (g) | * | 31.2 | 23.2 |
| Structural Analysis Results | | | |
| Wt % Carbonate linkage in polymer | 28.3 | 30.6 | 15.9 |
| Wt % CO₂ in polymer | 7.7 | 7.5 | 4.1 |
| Wt % CO₂ in PO Chain | 9.4 | 13.7 | 6.4 |
| Structural Data (See Formula 7) | | | |
| Propylene carbonate Units (b) | 1.6 | 0.5 | 0.5 |
| Propylene Ether Units (a) | 11.3 | 4 | 5.2 |
| Biodegradability Tests† | | | |
| Time to achieve 10% D_{CO2} | 7.6 | | 5.8 |
| D_{CO2} at Day 28 | 49.7 ± 10.8 | | 67.5 ± 2.9 |

* Not measured
†Biodegradability is measured on the hydrophobic intermediate blocks. Our experience shows that adding hydrophilic blocks increases biodegradability.

Analysis of the hydrophobic polymer intermediate by carbon-13 NMR confirm that the product meets Formula 8:

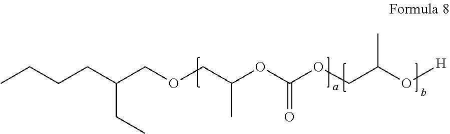

in which a and b are shown in Table 1.

Comparative Examples: The reactor is a 2000 mL Parr stainless steel (316 SS) reactor equipped with an impeller, a dip tube (¼″ inch OD) that is connected to nitrogen line and oxide feed line, and separate nitrogen and vent lines in the head of the reactor. Heating is provided by an external electric band heater and cooling is provided by water circulated through an internal coil with flow control provided by a research control valve. Process control is achieved with Siemens PCS7 using pressure and temperature inputs from the reactor. Oxide is fed from an intermediate feed tank driven by pressure differential, measured with an in-line flow meter, and controlled with flow control valve.

Potassium hydroxide and 2-ethylhexanol are mixed in a round bottom flask followed by stripping by rotoevaporation at 75° C. to a final water content less than 500 ppm. The catalyzed alcohol is charged to the reactor and inerted by a nitrogen pad/de-pad sequence (6 cycles). The reactor is heated to 100-130° C. under nitrogen pressure. Propylene oxide is charged to the reactor while maintaining a pressure of less than 58 psia and digested for 1 hour upon completion. The product is cooled to 65° C. and drained from the reactor. The crude product is neutralized with glacial acetic acid. The resulting product is an oligomer having on average about 5 repeating units of propylene carbonate bonded to the 2-ethylhexanol. The product is then mixed with 100 ppm DMC catalyst for direct comparison of biodegradability with the Inventive Examples (Int 1, Int 2, and Int 3).

Comparative Examples take 4.6 days to achieve 10% D_{CO2}, and after 28 days achieve 33.8 D_{CO2}, ±9.86.

### Example 2: Preparation of Polyether Carbonate Surfactants

A quantity (shown in Table 2) of the hydrophobic polymer intermediate product (shown in Table 2) from Example 1 (containing DMC catalyst and promoter) are added into a 500 mL stainless steel reactor are in an open laboratory atmosphere. Further catalyst and promoter are added to reach the quantity shown in Table 2. The reactor is closed and placed under nitrogen sparge overnight at room temperature to inert the atmosphere. The reactor is then heated to the reaction temperature shown in Table 2 over 1 hr with a continuous sparge and maintained at that temperature throughout the reaction. The nitrogen sparge is then turned off and the reactor is isolated.

A 5 g quantity of ethylene oxide is added to the reactor using a 0.4 g/min flow rate. The feed is shut off, and the pressure is allowed to decline to the initial pressure or until heat evolution has ceased. Then, further ethylene oxide is fed to the reactor until the quantity shown in Table 2 has been reached. After the ethylene oxide feed is completed, the residual ethylene oxide in the reactor is allowed to digest at temperature and then the remaining pressure is vented to the scrubber while nitrogen is sparged through the reactor body. After the reactor atmosphere has reached ambient pressure, the sparge is continued for 30 mins and the reactor is allowed to cool to ambient temperature. When the reactor is at ambient temperature, the product is recovered.

Analysis of the hydrophobic polymer intermediate by carbon-13 NMR confirm that the surfactant meets Formula 9:

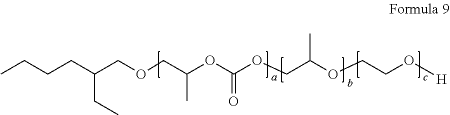

in which a, b and c are shown in Table 2.

Comparative nonionic surfactants (CE1 and CE2) are made using the same procedures with the comparative hydrophobic blocks made in Example 1. The following measurements are performed in the inventive examples (IE1 and IE2) and the comparative examples (CE1 and CE2) using test methods listed above, and results are listed in Table 2: surface tension in an aqueous solution that contains 0.1 weight percent of surfactant; critical micelle concentration; and Draves wetting time in an aqueous solution that contains 0.1 weight percent of surfactant.

TABLE 2

| Sample ID | IE1 | IE2 | CE 1 | CE 2 |
|---|---|---|---|---|
| Reagents | | | | |
| Intermediate | Int 1 | Int 2 | | |
| Quantity of Intermediate (g) | 122.9 | 150 | | |
| Quantity of Ethylene Oxide (g) | 74.9 | 135 | | |
| Conditions | | | | |
| DMC concentration per surfactant | 150 | 150 | | |
| product [ppm] | | | | |
| Promoter:DMC ratio: Al:Zn (mol) | 6:1 | 6:1 | | |
| Temperature [C.] | 130 | 100 | | |
| N2 purge temperature [C.] | Ambient | Ambient | | |
| N2 flow rate [SCFH] | 0.5 | 0.5 | | |
| N2 purge time [h] | Overnight | Overnight | | |
| Measured Units per 2-Ethylhexanol | | | | |
| Propyl Carbonate (a) | 1.6 | 0.5 | 0 | 0 |
| Propyl Ether (b) | 11.3 | 4 | 9 | 5.5 |
| Ethyl ether (c) | 12 | 6 | 9 | 8 |
| Performance Tests | | | | |
| Surface Tension at 0.1 wt % aq | 30 | 31 | 30 | 30 |
| (dyne/cm.) | | | | |
| Critical Micelle Concentration (ppm) | 259 | 1596 | 323 | 794 |
| Draves Wetting Time at 0.1 wt % aq | 30 | 17 | 14 | 18 |
| (sec) | | | | |

The performance tests in Table 2 show that nonionic surfactants of the present invention exhibit surfactant performance that is similar to nonionic surfactants that do not contain carbonate linkages. The biodegradability tests in Table 1 show that nonionic surfactants of the present invention have higher biodegradability than nonionic surfactants that do not contain carbonate linkages

1. A nonionic surfactant comprising:
a) hydrophobic polymer blocks that contain on average from 60 to 99 weight percent alkylene ether repeating units and from 1 to 40 weight percent alkylene carbonate repeating units, based on the combined weight of alkylene ether repeating units and alkylene carbonate repeating units; and
b) hydrophilic polymer blocks that contain alkylene ether repeating units.

2. The nonionic surfactant of claim 1 wherein the hydrophobic polymer blocks further comprise an aliphatic moiety having 1 to 30 carbon atoms bonded to one of the repeating units by an ether or ester linking group.

3. The nonionic surfactant in claim 1, wherein the hydrophobic polymer blocks contain on average from 5 to 35 weight percent of alkylene carbonate repeating units, based on the combined weight of alkylene carbonate and alkylene ether repeating units.

4. The nonionic surfactant in claim 1, wherein the hydrophobic polymer blocks contain on average from 8 to 30 weight percent of alkylene carbonate repeating units, based on the combined weight of alkylene carbonate and alkylene ether repeating units.

5. The nonionic surfactant in claim 1, wherein the hydrophobic polymer blocks have an average degree of polymerization from 2 to 35.

6. The nonionic surfactant in claim 1, wherein the hydrophilic polymer blocks have an average degree of polymerization from 3 to 70.

7. The nonionic surfactant in claim 1, wherein the nonionic surfactant contains on average from 30 to 90 weight percent of the hydrophilic polymer blocks.

8. The nonionic surfactant in claim 1, wherein alkylene groups in the alkylene ether and alkylene carbonate repeating units of hydrophobic polymer blocks contain on average at from 3 to 6 carbon atoms, and alkylene groups in the alkylene ether repeating units of hydrophilic polymer blocks contain on average from 2 to 2.5 carbon atoms.

9. The nonionic surfactant in claim 2 which has a critical micelle concentration from 50 ppm to 1500 ppm.

10. The nonionic surfactant in claim 1 which meets 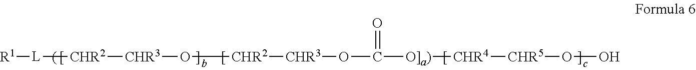
Formula 6:
Wherein:
R¹ is an organic moiety containing 1 to 30 carbon atoms.
L is an ether linking group (—O—) or an ester linking group (—CO₂—).
Each R² and R³ is independently hydrogen or an alkyl moiety selected such that in each repeating unit R² and R³ together contain on average from 1 to 4 carbon atoms.
Each R⁴ and R⁵ is independently hydrogen or an alkyl moiety selected such that in each repeating unit R⁴ and R⁵ together contain on average from 2 to 2.7 carbon atoms.
The repeating units between the parentheses ( ) form the hydrophobic polymer block(s), and the repeating units outside the parentheses form the hydrophilic polymer block(s).
a is a number of repeating units that averages from 0.7 to 18, b is a number of repeating units that averages from 2 to 35, and c is a number of repeating units that averages from 3 to 70.
The alkylene ether repeating units and the alkylene carbonate repeating units in the hydrophobic polymer block(s) may be randomly or alternately distributed or the hydrophobic polymer block(s) may have segments containing higher or lower concentrations of alkylene carbonate units, and the first unit attached to the linking group L may be an alkylene ether unit or an alkylene carbonate unit.

11. A process to make a nonionic surfactant in claim 1 comprising the steps of:
a) A first polymerization step in which a first alkylene oxide component is polymerized in the presence of carbon dioxide, an alcohol or organic acid and a catalyst under conditions such that hydrophobic polymer blocks are formed that contain on average from 60 to 99 weight percent alkylene ether repeating units and from 1 to 40 weight percent alkylene carbonate repeating units, based on the combined weight of alkylene ether repeating units and alkylene carbonate repeating units; and
b) A second polymerization step in which a second alkylene oxide component is polymerized in the presence of hydrophobic polymer blocks from step (a) and a catalyst, under conditions such that hydrophilic polymer blocks that contain alkylene ether repeating units are formed attached to the hydrophobic blocks.

12. The process in claim 11 wherein the catalyst in both the first polymerization step and the second polymerization step comprises a double metal cyanide catalyst.

13. The process in claim 11, wherein the first alkylene oxide component comprises on average from 3 to 6 carbon atoms per molecule, and the second alkylene oxide component comprises on average from 2 to 2.7 carbon atoms per molecule.

14. The process in claim 11, wherein the uptake of carbon dioxide into the hydrophobic polymer blocks formed in the first polymerization step is from 5 to 20 weight percent.

15. The process in claim 11, wherein the weight ratio of the second alkylene oxide component to the hydrophobic polymer blocks in the second polymerization step is from 0.4 to 9.
